(19) United States
(12) Patent Application Publication
(10) Pub. No.: US 2023/0359500 A1
(43) Pub. Date: Nov. 9, 2023

(54) COMPUTING SYSTEM MANAGEMENT

(71) Applicant: NOKIA SOLUTIONS AND NETWORKS OY, Espoo (FI)

(72) Inventors: Xinmiao LI, Hangzhou, Zhejiang (CN); Wei CHEN, Hangzhou, Zhejiang (CN); Huanqiu YE, Hangzhou, Zhejiang (CN); Xianhua HE, Hangzhou, Zhejiang (CN); Jun HE, Hangzhou, Zhejiang (CN); Kefeng LIU, Hangzhou, Zhejiang (CN)

(21) Appl. No.: 18/026,241

(22) PCT Filed: Oct. 21, 2020
(86) PCT No.: PCT/CN2020/122570

§ 371 Date: Mar. 14, 2023

(51) Int. Cl. G06F 9/50; G06F 11/34; G06F 11/30

(52) U.S. Cl. CPC G06F 9/505; G06F 11/3414; G06F 11/3024

(57) ABSTRACT

Example embodiments of the present disclosure relate to computing system management. A plurality of previous workloads of a computing system for a previous time duration are obtained. Workload estimation is determined for a future time duration based on the plurality of previous workloads. Based on the workload estimation, management profile is selected from a group of management profiles for managing the computing system for the future time duration. With the example embodiments, the computing system is managed in a flexible and effective way.

### FIELD

Embodiments of the present disclosure generally relate to a computing system, and in particular, to a method, device, apparatus and computer readable storage medium for managing an operation of the computing system.

### BACKGROUND

With developments of computer and communication techniques, various types of computing systems may provide different functions. For example, a communication system may provide users with communication services, a data processing system may provide the users with processing abilities, and a storage system may provide the users with storage spaces. Data entering into the computing system often varies, and thus workloads of the computing system also changes. In order to provide high QoS (Quality of Service), resources in the computing system are maintained in active states such that incoming data may be quickly processed. However, there are excessive active resources than requirements during idle hours, and thus it leads to undesired performance (such as unnecessary energy consumptions by the active resources, low efficiency in workload balance, and the like) of the computing system.

There have been proposed solutions for managing operations of the computing system based on workload monitoring and estimating. However, it is difficult to accurately estimate future workloads and define a threshold for triggering a management procedure based on the estimated future workloads. Therefore, efficient management solutions are still needed in various computing systems.

### SUMMARY

In general, example embodiments of the present disclosure provide a solution for managing a computing system.

In a first aspect, there is provided a device. The device comprises: at least one processor; and at least one memory including computer program codes; the at least one memory and the computer program codes are configured to, with the at least one processor, cause the device to: obtain a plurality of previous workloads of a computing system for a previous time duration; determine workload estimation for a future time duration based on the plurality of previous workloads; select, based on the workload estimation, a management profile from a group of management profiles for managing the computing system for the future time duration.

In a second aspect, there is provided a method. The method comprises: obtaining a plurality of previous workloads of a computing system for a previous time duration; determining workload estimation for a future time duration based on the plurality of previous workloads; and selecting, based on the workload estimation, a management profile from a group of management profiles for managing the computing system for the future time duration.

In a third aspect, there is provided an apparatus. The apparatus comprises: means for obtaining a plurality of previous workloads of a computing system for a previous time duration; means for determining workload estimation for a future time duration based on the plurality of previous workloads; means for selecting, based on the workload estimation, a management profile from a group of management profiles for managing the computing system for the future time duration.

In a fourth aspect, there is provided a non-transitory computer readable medium. The non-transitory computer readable medium comprises program instructions for causing an apparatus to perform at least a method. The method comprises: obtaining a plurality of previous workloads of a computing system for a previous time duration; determining workload estimation for a future time duration based on the plurality of previous workloads; and selecting, based on the workload estimation, a management profile from a group of management profiles for managing the computing system for the future time duration.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure may be implemented;

FIG. 2 illustrates a block diagram of an operation of a computing system according to some example embodiments of the present disclosure;

FIG. 3 illustrates a block diagram of a procedure for managing an operation of a computing system according to some example embodiments of the present disclosure;

FIG. 4 illustrates a flowchart of a method for managing an operation of a computing system according to some example embodiments of the present disclosure;

FIG. 5 illustrates a block diagram of a machine learning network for determining workload estimation according to some example embodiments of the present disclosure;

FIG. 6 illustrates a block diagram of a procedure for selecting a management profile according to some example embodiments of the present disclosure;

FIG. 7 illustrates a block diagram of a position of a previous time window for determining a false ratio according to some example embodiments of the present disclosure;

FIG. 8 illustrates a block diagram of a procedure for selecting a further management profile based on a performance degradation in a computing system according to some example embodiments of the present disclosure;

FIG. 9 illustrates a simplified block diagram of an apparatus that is suitable for implementing some example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an

Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

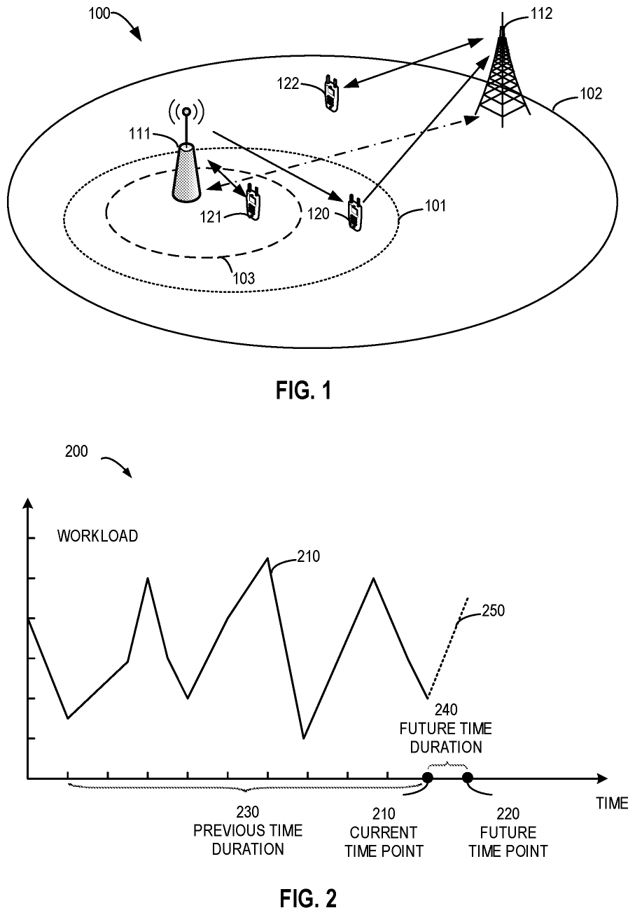

Principle and embodiments of the present disclosure will be described in detail below with reference to the accompanying drawings. Reference is first made to FIG. 1, which illustrates an example communication system 100 in which embodiments of the present disclosure may be implemented. The system 100 includes a plurality of network devices, such as a network device 111 and a network device 112. The network devices 111, 112 serve respective areas 101 and 102 (also called as cells 101 and 102) using different frequency bands in both DL and UL. Such a frequency band may also be referred to as an operating frequency band of the corresponding network device.

The system 100 also includes one or more terminal devices, such as terminal devices 120, 121, 122. The terminal devices 120, 121, 122 are capable of connecting and communicating in an UL and DL with either or both of the network devices 111, 112 as long as the terminal devices located within the corresponding cells. In communication systems, an UL refers to a link in a direction from a terminal device to a network device, and a DL refers to a link in a direction from the network device to the terminal device. In addition to communicating the terminal devices 120, 121, 122, the network devices 111, 112 may also communicate with each other, for example, via a backhaul link.

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the cell 101 or 102.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and

Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The coverage ranges of the cells of the network devices 111 is tightly related to the operating frequency bands of the network devices 111, 112. FIG. 1 shows an example where the operating frequency bands of the network devices are different, with the operating frequency band of the network device 111 higher than the operating frequency band of the network device 112. It is very possible that the coverage range of the cell 101 is smaller than that of the cell 102, due to a more serious path-loss situation in the high frequency band system. In the shown example, the cell 101 is overlapped with the cell 102. The large cell 102 may sometimes be referred to as a macro cell and the network device 112 may be referred to as a macro base station, while the relatively small cell 101 may sometimes be referred to as a small cell and the network device 111 may be referred to as a small base station. As a specific example, the network device 111 may be operating at sub 6 GHz, such as 3.5 GHz, while the network device 112 may be operating at a millimetre-wave (mmW) frequency band, such as at 28 GHz. It is to be understood that other operating frequency bands are also possible for the network devices 111, 112.

In some scenarios, the cell 101 and/or the cell 102 may have an asymmetric UL and DL budget. Such asymmetric budget easily happens in a cell with a high frequency band. For example, in a case of operating at the mmW frequency band, the different budget between the UL and DL may be up to 25 dB. FIG. 1 shows that the asymmetric UL and DL in the cell 101. For example, the cell 101 includes an UL coverage area 103 and a DL coverage area that is the same as the range of the cell 101. The UL coverage area 103 is smaller than the DL coverage area. For example, up to 25 dB budget difference may lead to a situation where the UL coverage area is only about ¼ of the DL coverage area. The main reasons are the small UL transmission power of terminal devices and/or smaller UL transmission beamforming gain, as compared with the DL case.

In the context of the present disclosure, a computing system may comprise various types such as the communication system 100 as described above. In other example embodiments of the present disclosure, the computing system may comprise a processing system, a storage system, and the like. For the purpose of description, the communication system will be taken as example of the computing system. Reference will be made to FIG. 2 for a general description of an operation of the computing system. FIG. 2 illustrates a block diagram 200 of an operation of a computing system according to some example embodiments of the present disclosure. As known, workloads of the computing system may vary as time goes. FIG. 2 illustrates a time line during operations of the computing system, where a horizontal axis indicates the time, and a vertical axis indicates the workload.

In FIG. 2, a curve 210 represents workloads at various time points during the operation of the computing system. Here, the workload may be represented by multiple formats including but not limited to the number of available physical resource blocks (PRBs), a percentage of the available PRBs, a data amount entering into the computing system, and so on. As illustrated by the curve 210, the workload varies during a previous time duration 230 before a current time point 210. The previous workloads may be obtained for determining workload estimation (illustrated by a dash line 250) for a future time duration 240 between the current time point 210 and a future time point 220. Here, the time may be represented by a week, a day, an hour, a minute, and the like.

There have been proposed solutions for managing the computing system based on the previous workloads. In some solutions, workloads of the computing system are monitored and a threshold workload is predefined. If the monitored workloads are below the threshold workload for a predetermined time duration (for example, 5 minutes), then it is determined that the computing system is in an idle state and a management procedure may be triggered. For example, a portion of resources in the computing system may be deactivated for saving energy. However, this solution cannot provide accurate estimation for the future. Sometimes peak traffic immediately comes and thus active resources are not enough for handling the incoming peak. Meanwhile, it is hard to define the threshold workload for triggering the management procedure. If the threshold workload is too high, the management cannot achieve a good effect in energy saving; and if the threshold workload is too low, the limited active resources in the computing system cannot handle the incoming traffic.

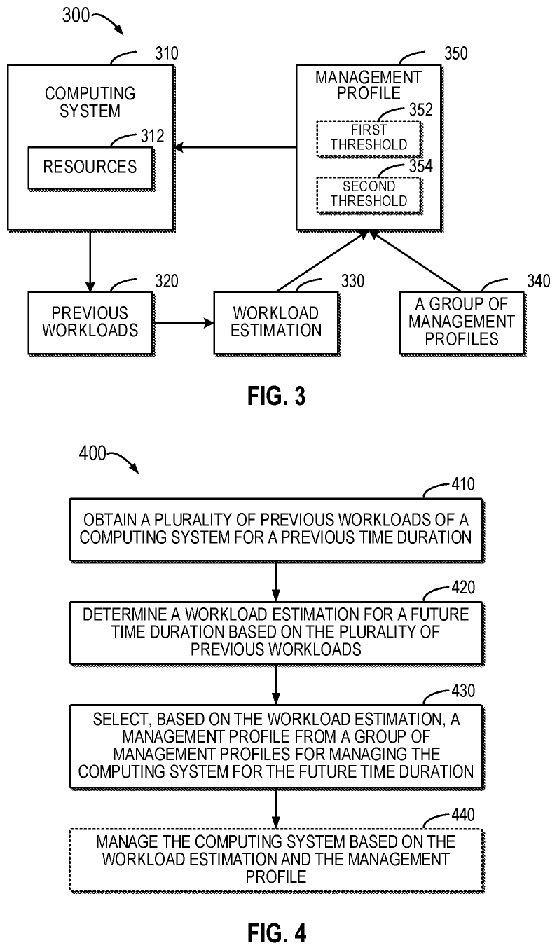

In order to remove at least some of the above drawbacks, the present disclosure proposes a method for managing an operation of a computing system. In the present disclosure, a group of management profiles may be defined in advance. Here, the group of management profiles may define different threshold ranges for triggering the management procedure, and a suitable management profile may be selected therefrom. Reference will be made to FIG. 3 for a general description of the proposed method. FIG. 3 illustrates a block diagram of a procedure 300 for managing an operation of a computing system according to some example embodiments of the present disclosure. In FIG. 3, a computing system 310 may comprise resources 312 that are applied in the computing system 310 for processing the inputted data. In busy hours, all these resources may be switched on to provide full processing ability; and in idle hours, some resources may be switched off for saving energy. In some example embodiments of the present disclosure, the applied resources may refer to available resources in the computing system. Specifically, in a communication system, the applied resources may refer to available PRBs that may be allocated for the incoming traffic; and in a processing system, the applied resources may refer to available CPU capacity for processing the incoming traffic.

Here, workloads of the computing system may be monitored, and previous workloads 320 collected at a plurality of time points during the previous time duration 230 may be obtained for determining workload estimation 330 for the future time duration 240. Based on the workload estimation 330, a management profile 350 may be selected from the group of management profiles 340 for managing the computing system 310. In these example embodiments, the management profile 350 may comprise threshold(s) for triggering the management procedure. For example, the management profile 350 may comprise a first threshold 352. If the workload estimation 330 is above the first threshold 352, then a portion of resources 312 in the computing system 310 may be switched on for handling more traffic. The management profile 350 may comprise a second workload 354 which is lower than the first threshold 352 for trigger reverse management. If the workload estimation 330 is below the second threshold 354, then a portion of resources in the computing system may be switched off for saving energy.

With these example embodiments, a suitable management profile 350 may be selected based on the workload estimation 330, therefore the present disclosure provides a dynamic threshold for triggering the management procedure. Compared with a conventional solution where a fixed threshold is predefined, the example embodiments may select an adaptive management profile based on the workload estimation 330 and thus the computing system 310 may be managed in an effective way.

Hereinafter, reference will be made to FIG. 4 for more details about the proposed method. FIG. 4 illustrates a flowchart of a method 400 for managing an operation of a computing system according to some example embodiments of the present disclosure. At a block 410, a plurality of previous workloads of a computing system for a previous time duration are obtained. In the current massive MIMO (massive Multiple Input Multiple Output, mMIMO) communication system, the resources may relate to carrier layer, mMIMO RRH TX/RX, baseband DSP pool, DTX muting, and the like. Depending on types of the computing system and resources in the computing system, the workload may be represented by various formats. For example, the workload may be represented by the number of available PRBs, or a usage percentage of the available PRBs. Alternatively and/or in addition to, in a processing system, the workload may be represented by a usage ratio of a processor, a usage ratio of a memory, a frequency of processing requests, and the like; and in a storage system, the workload may be represented by occupied storage space in the storage system, and the like.

In some example embodiments of the present disclosure, the previous workloads 320 may be collected during the previous time duration 230, and then stored in a buffer device. Further, the previous workloads may be obtained from the buffer device. In some example embodiments of the present disclosure, a length of the previous time duration 230 and a period for collecting the workload may be defined in advance. For example, the previous time duration 230 may comprise two weeks and the workload may be collected at every 15 minutes. At this point, workloads in one day include (60/15)*24=96 measurements, and the group of previous workloads in two weeks include 96*14=1344 measurements.

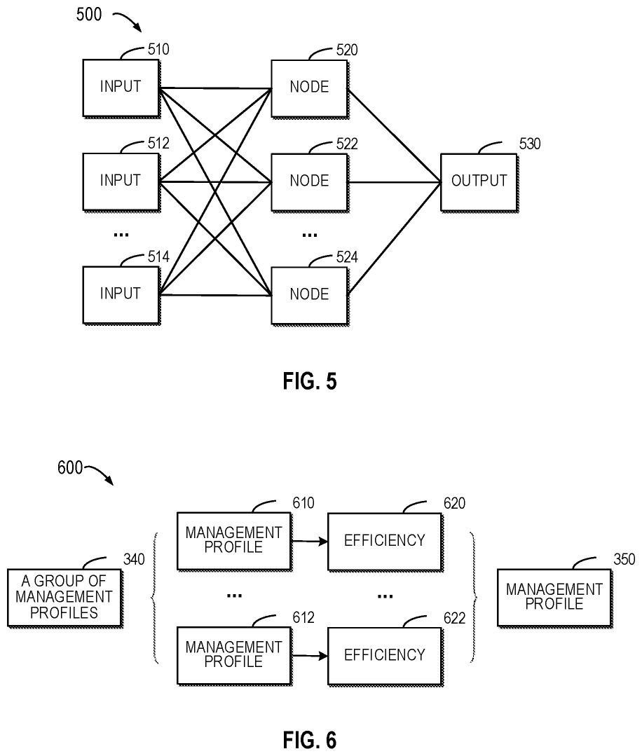

At a block 420, workload estimation 330 is determined for the future time duration 240 based on the plurality of previous workloads 320. Here, machine learning techniques may be adopted for determining the workload estimation. Reference will be made to FIG. 5 for more details, which figure illustrates a block diagram of a machine learning network 500 for determining workload estimation according to some example embodiments of the present disclosure. In FIG. 5, the machine learning network 500 is implemented by a multi-layer perceptron network, and the network 500 may comprise 96 inputs 510, 512, . . . , and 514. The workloads (at an interval of 15 minutes) in one day may enter the network 500 via these inputs 510, 512, . . . , and 514. The network 500 may have an output 530 and a hidden layer including nodes 520, 522, . . . , 524.

Here, the inputs and nodes in the hidden layer may be connected based on a full connection way, and nodes in the hidden layer may be connected to the output 530. Further, a corresponding weight may be assigned for each of the connections, and the network 500 may be trained based on the previous workloads. In some example embodiments, a RELU function including the above weights may be defined for representing an association between the workload estimation and the previous workloads. Then, values of these weights may be determined based on a root means square error. In some example embodiments of the present disclosure, the RELU function may be generated based on the following Formula 1:

$$L = \{ \begin{matrix}0 , SW + b < 0 \\ SW + b , SW + b \geq 0\end{matrix} \qquad Formula 1$$

Where L represents a non-linear activation function, S represents the inputted workloads, W represents a matrix including the above weights, and b represent an offset. Initially, W is defined with random values according to a normal distribution, and b is set to a constant value. During the training, W and b may be continuously updated in each epoch of the training until a predefined criterion is met.

In some example embodiments of the present disclosure, the criterion may be based on the following Formula 2:

$$R M S E = \sqrt{\frac{1}{m} {\sum }_{i = 1}^{m} {( {y}_{i} - {\hat{y}}_{i} )}^{2}} \qquad Formula 2$$

Where RMSE represents a root mean square error related to an actual workload and the workload estimation, yᵢ represents the actual workload, ŷᵢ represents the workload estimation, and m represents the number of the sample data for training the above RELU function. During the training, W and b that lead to a minimum RMSE may be selected for the RELU function. It is to be understood that the above Formulas 1 and 2 are just examples for training the network 500. Alternatively and/or in addition to, other types of networks and other training approaches may be utilized for determining the workload estimation 330 based on previous workloads 320.

Here, each of the above 96 measurements may be represented by 4 bytes and thus a size of the total previous workload for two weeks may work as the training data and be saved in a storage space of 96*14*4=16128 bytes. As the size of the total training data is relatively small, it may be stored in a local storage in a processor in the computing system.

Further, each training procedure may take about 100 ms and thus the processor may provide enough processing ability. In the above environment of the communication system, the training and estimating may be implemented by a processing chip in a base station or another type of device with computing ability in the communication system.

Once the workload estimation 330 is determined, a management profile matching the workload estimation 330 may be selected. Reference will be made back to FIG. 4 for further descriptions. At a block 430, based on the workload estimation 330, the management profile 350 is selected from the group of management profiles 340 for managing the computing system 310 for the future time duration 240. Here, the group of management profiles 340 may be defined in advance, for example, these profiles may be defined based on historical experience for controlling the computing system 310. In some example embodiments of the present disclosure, the management profile 350 may comprise a first threshold 352 and a second threshold 354 for controlling various aspects of the computing system. For example, a power supply of the computing system 310 may be managed based on these thresholds. An example of the group of management profiles 340 are provided in Table 1 as below.

TABLE 1
Example of Group of Management Profile

| Profile ID | First Threshold | Second Threshold |
|---|---|---|
| 1 | 40% | 20% |
| 2 | 50% | 20% |
| 3 | 50% | 25% |
| 4 | 60% | 25% |
| 5 | 60% | 30% |
| 6 | 70% | 30% |
| 7 | 70% | 35% |

In Table 1, the first threshold represents a threshold for increasing the applied resources in the computing system (i.e., switch on more resources), and the second threshold represents a threshold for decreasing the applied resources in the computing system (i.e., switch off some resources). In the communication system, the applied resources may relate to a power supply for the PRBs, and more PRBs may be provided when the power supply is increased for switching on more resources. Hereinafter, the power supply will be taken as an example of the applied resources for providing more details about example embodiments of the present disclosure.

According to the first profile in Table 1, if the workload estimation 330 (which is represented by a usage percentage of available PRBs) is greater than 40%, then the power supply may be increased for switching on more resources; and if the workload estimation 330 is less than 20%, then the power supply may be decreased for switching off some resources. If the workload estimation 330 is between 20% and 40%, then the power supply may be maintained to a current level. In the second profile, the first threshold is set to 50% and the second threshold is set to 20%, therefore the second profile may save more energy than the first profile.

Besides management of the power supply, other aspects of the computing system may be managed based on the above profiles. For example, a data amount that is to be processed by the computing system may be adjusted. Once the first profile is selected, if the workload estimation 330 is greater than 40%, then a portion of the data that is inputted into the computing system may be forwarded to another computing system, so as to decrease the to-be-processed data amount); and if the workload estimation 330 is less than 20%, then data amount may be increased (for example, data may be received from another computing system with a heavy workload); if the workload estimation 330 is between 20% and 40%, then the data amount may be maintained to a current level.

In some example embodiments of the present disclosure, the management profile 350 may be selected based on efficiency associated with the management profile 350. Specifically, an efficiency score may be determined for each management profile in Table 1. Reference will be made to FIG. 6 for more details, where FIG. 6 illustrates a block diagram of a procedure 600 for selecting a management profile according to some example embodiments of the present disclosure. In FIG. 6, the group of management profiles 340 comprise management profile 610, . . . , and 612. With respect to each of the management profiles, a corresponding efficiency may be determined. Here, the efficiency may represents an effect for adopting the management profile. In some example embodiments of the present disclosure, the efficiency for the computing system associated with the management profile may be determined based on an amount of applied resources that are to be saved in the computing system by a decrease of the applied resources. In the environment of managing the power supply of the computing system, the efficiency may be determined based on an amount of energy that is to be saved by a decrease of the power supply to the resources in the computing system.

For example, if a management profile is selected, the power-on time duration of the resources is decreased according to the second threshold, then the energy consumption of the resources may be decreased, such that the management profile leads to a lower energy consumption and thus achieves a better effect. Various methods may be used to determine the power-on time duration. Specifically, the following Formula 3 may be used.

Efficiency(i)=Σᵥ₌₁^{v=N}E_{saved}^{{v+1}}(Sᵢ^{{v+1}}(l^{{v}})) Formula 3

Where i represents an ID of the management profile, Efficiency(i) represents the efficiency for the i^{th} management profile, N represents a configurable parameter for a cycle of the profile selection, v represents the current time period, l^{{v}} represents workload estimation at the end of the current time period v, Sᵢ^{{v+1}} represents ON/OFF state of the resources in the future time period (v+1) based on the selected i^{th} management profile, and E_{saved}^{{v+1}}(Sᵢ^{{v+1}}(l^{{v}})) represents the energy saving value in the future time period (v+1) which is calculated by the power-off time duration.

The above Formula 3 may be applied to each of the management profiles in the above Table 1, and thus each management profile may have a corresponding efficiency score. Then, a management profile with the maximum efficiency may be selected for managing the computing system. With the selected management profile, the energy saving effect may be maximized in the computing system and thus more energy may be saved.

It is to be understood that the above Formula 3 is just an example for determining the efficiency score, and modifications may be made to the above Formula 3 and more factors may be considered in determining the efficiency score. It is to be understood that the workload estimation 350 is determined based on the previous experience and may not be always in consistent with the actual workload. Therefore, based on the incorrect workload estimation, the computing system may be incorrectly managed. For example, if the first profile is selected, the workload estimation is 15% but the actual workload is 25%, the power supply may be incorrectly decreased because 15% is below the second threshold 20%. Therefore, the above situation may be considered to provide a more accurate control to the computing system.

In some example embodiments of the present disclosure, a false ratio may be determined, and the false ratio refers to a ratio between the number of incorrect operations (which incorrectly manages the computing system based on the workload estimation and the management profile) and the number of total management operations. At this point, the incorrect operations may relate to two types: a false operation which incorrectly decreases the applied resources according to an incorrect workload estimation (actually, the applied resources should not be decreased according to an actual workload); and a false operation which incorrectly maintains the applied resources unchanged and fails to increase the applied resources according to an incorrect workload estimation (actually, the applied resource should be increased according to an actual workload). Therefore, the false ratio may comprise any of: a false decreasing ratio for incorrectly decreasing the applied resources in the computing system; and a false maintaining ratio associated with failing to increase the applied resources for the resources in the computing system.

In the above environment for managing the power supply, the false decreasing ratio is related to an incorrect decrease of the power supply. The following paragraphs will describe how to determine the false decreasing ratio first. In some example embodiments, the false decreasing ratio may be determined based on the following Formula 4.

$$K 1 = \frac{sum ( {Load}_{act} > Min ) \&\& ( {Load}_{est} \leq Min )}{sum ( {Load}_{act} > Min )} \qquad Formula 4$$

Where K1 represents the false decreasing ratio, sum represents a function to calculate a sum, Load_{act} represents the actual workload of the computing system, Loadₑₛₜ represents the workload estimation of the computing system, Min represents the minimum threshold (i.e., the second threshold) in the management profile, and && represents a logical operation AND.

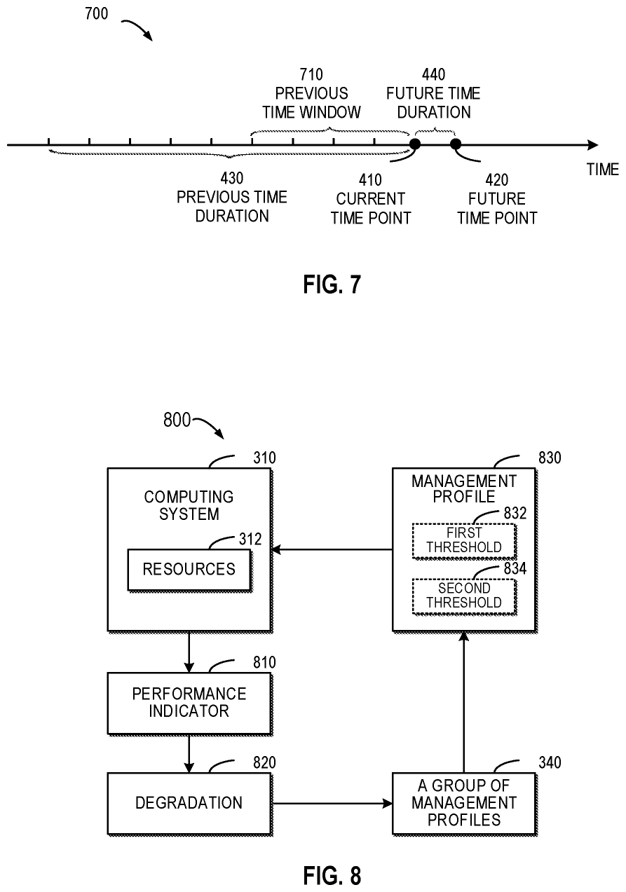

It is to be understood that when the false decreasing ratio is calculated, the actual workload for the future time period (v+1) cannot be obtained at the current time point, therefore the false decreasing ratio may be calculated based on actual and estimated workloads collected during a previous time window. Reference will be made to FIG. 7 for more details about the previous time window. FIG. 7 illustrates a block diagram 700 of a position of a previous time window 710 for determining a false ratio according to some example embodiments of the present disclosure. As illustrated in FIG. 7, the previous time window 710 may locate within the previous time duration 430. For example, the previous time window 710 may be at the end of the previous time duration 430 and ends at the current time point 410. The length of the previous time window 710 may be defined in advance. For example, the previous time window 710 may have a length of 1 hour or another value.

As shown in FIG. 7, the previous time window 710 is close to the current time point 410, therefore the actual and estimated workloads at a plurality of time points in the previous time window 710 are the latest data collected in the computing system. Accordingly, the latest data can reflect a variation tendency of the future workloads, which provides an accurate ground for determining the false decreasing ratio. With the above Formula 4, the false decreasing ratio may be determined in an easy and effective way. Supposing the previous time window 710 is set to 1 hour, and thus four pairs of Load_{act} and Loadₑₛₜ may be collected at every 15 minutes within the hour. The collected data may be input into Formula 4 for determining the false decreasing ratio. In some example embodiments, the previous time window 710 may slide forward as time goes, therefore the false ratio may be updated continuously.

In the above environment for managing the power supply, the false maintaining ratio is related to an incorrect maintaining of the power supply. In some example embodiments of the present disclosure, the false maintaining ratio may be determined in a similar manner based on the following Formula 5.

$$K 2 = \frac{sum ( {Load}_{act} > Max ) \&\& ( {Load}_{est} \leq Max )}{sum ( {Load}_{act} > Max )} \qquad Formula 5$$

Where K2 represents the false maintaining ratio, sum represents a function to calculate a sum, Load_{act} represents the actual workload of the computing system, Loadₑₛₜ represents the workload estimation of the computing system, and Max represents the maximum threshold (i.e., the first threshold) in the management profile, and && represents a logical operation AND. With the above Formula 5, the false maintaining ratio may be determined in an easy and effective way.

In some example embodiments of the present disclosure, the above false ratio K1 and K2 may also be considered to determine the efficiency associated with the management profile. Specifically, the following Formula 6 may be used for determining the efficiency.

$$Efficiency ( i ) = ( 1 - α ) * {\sum }_{v = 1}^{v = N} {E}_{saved}^{\{ v + 1 \}} ( {S}_{i}^{\{ v + 1 \}} ( {l}^{\{ v \}} ) ) - α * \frac{K 1 + K 2}{2} \qquad Formula 6$$

Where α represents a weight for the false ratio, usually α is set to 0.5 or another value between 0 and 1. Other symbols in Formula 6 may have the same definitions as those in Formulas 3, 4 and 5.

In some example embodiments of the present disclosure, a target amount of applied resources may be defined for representing a desired amount that is to be saved in the computing system by the decrease of the applied resources. Here, the target amount may be determined based on a state of the computing system related to the actual workload. The target amount may be uniform for all the management profile. For example, in the above environment for managing the power supply, the target amount may be defined by an amount of energy that is to be saved by a decrease of the power supply. One example target amount may be determined based on a maximum threshold 70% for switching on some resources in the computing system and a minimum threshold 35% for switching off some resources. Further, the efficiency associated with the i^{th} management profile may be determined based on the following Formula 7.

$$Efficiency ( i ) = ( 1 - α ) * \frac{{\sum }_{v = 1}^{v = N} {E}_{saved}^{\{ v + 1 \}} ( {Si}^{\{ v + 1 \}} ( {l}^{\{ v \}} ) )}{{\sum }_{v = 1}^{v = N} {E}_{saved}^{\{ v + 1 \} , target}} - α * \frac{K 1 + K 2}{2} \qquad Formula 7$$

Where Σᵥ₌₁^{v=N}E_{saved}^{{v+1},target} represents the target amount of energy that is to be saved, and other symbols in Formula 7 may have the same definitions as those in Formulas 3, 4, 5 and 6.

It is to be understood that the above Formulas 3-7 just provide example methods for determining the efficiency for a given management profile. In other example embodiments, the above Formulas may be modified. For example, the weight a in Formulas 6 and 7 may be removed for a situation where the energy saving and the false ratio have the same importance. Referring back to FIG. 6, the above Formulas may be used to determine the efficiency for each of the management profiles. Specifically, efficiency 620 is determined for the management profile 610, . . . , and efficiency 622 is determined for the management profile 612. In some example embodiments of the present disclosure, the management profile 350 that has a maximum efficiency may be selected.

Once the suitable management profile 350 is selected, it may be used for managing the computing system. Referring back to FIG. 4, at a block 440, the computing system is managed based on the workload estimation 330 and the management profile 350.

Specifically, the thresholds in the management profile 350 may be used to trigger the management procedure. If the workload estimation 330 is above the first threshold 352, the applied resources such as the power supply may be increased for switching on more resources in the computing system. With these example embodiments, some resources may be switched on in advance so as to deal with the incoming peak workload. If the workload estimation 330 is below the second threshold 354, the power supply may be decreased for the resources in the computing system. In other words, some of the resources may be switched off due to a valley in the workload. If the workload estimation 330 is between the first threshold 352 and the second threshold 354, then the power supply may remain unchanged for the resources in the computing system because the active resources match the workload estimation 330.

With these example embodiments of the present disclosure, resources in the computing system may be managed according to a dynamically selected management profile that is suitable for the workload estimation 330. Accordingly, the resources may be controlled in a more effective way, such that the performance of the computing system may be increased.

The above paragraphs have described how to reduce the energy consumption in the computing system. Although switching off some resources may save more energy, sometimes, the remaining active resources may not provide enough processing ability for l the incoming traffic. Therefore, performance of the computing system may be monitored in real time so as to decide whether an excessive energy saving profile is selected. In some example embodiments of the present disclosure, key performance indicators (KPIs) may be obtained in the computing system. Here, types of the KPIs may depend on the function of the computing system. In a communication system, parameters such as the E-RAB Setup success ratio, the RRC connection setup success ratio, the intra/inter eNB handover success ratio, the Average PDCP cell throughput DL/UL, the access success ratio, the drop ratio and the like may be monitored.

Reference will be made to FIG. 8 for more details, where FIG. 8 illustrates a block diagram of a procedure 800 for selecting a further management profile based on performance degradation in a computing system according to some example embodiments of the present disclosure. As illustrated in FIG. 8, a performance indicator 810 may be monitored periodically for the computing system 310, and then the quality of the performance indicator 810 may be determined. In some example embodiments, the monitoring period may be set to 1 hour or another value. If the quality remains good as usual, it indicates that the selected management profile does not apply a negative influence to the computing system. If the quality shows degradation, it indicates that selected management profile leads to negative influence and should be changed.

In FIG. 8, if degradation 820 of the performance indicator 810 is above a predefined threshold, it indicates that the selected management profile decreases the applied resources too much, and thus another management profile with less decrease in the applied resources may be selected. In other words, a further management profile that deactivates fewer resources may be selected. In FIG. 8, a management profile 830 may be selected from the group of management profiles 240, and a first threshold 832 of the management profile 830 may be below the first threshold 352 of the management profile 350. Alternatively and/or in additional to, a second threshold 834 may be below the second threshold 354 of the management profile 350.

In one example, initially, if the third management profile with the thresholds of 50% and 25% is selected and the workload estimation is 22%, the power supply may be decreased (25%>22%). In other words, at least one resource is switched off. Further, one or more KPI may be monitored, once the degradation of the KPI is above the predefined threshold, another management profile which leads to less energy saving may be selected. For example, in Table 1, the second management profile with the thresholds of 50% and 20% may be selected for controlling the power supply. At this point, as the workload estimation 25% is between the first threshold 50% and the second threshold 20%, the power supply will be maintained and no resources will be switch off. Compared with the third profile which switches off at least one resource, the second profile may prevent the KPI to degrade greatly.

In some example embodiments of the present disclosure, degradation in multiple KPIs may be used to determine whether the selected management profile applies a negative influence to the computing system. For example, KPIs such as access success ratio, handover success ratio and drop ration may be monitored periodically, and the following Formula 8 may be used to detect whether the influence is positive or negative.

Influence=(Deg_{Access success ratio≤th}1)&&(Deg_{Drop ratio}≤th3)tm Formula 8

Where Influence represents an influence of the management file (where 1 represents a positive influence and 0 represents a negative influence), Deg_{Access success ratio} represents degradition related to the access success ratio, Deg_{HO success ration} represents degradation related to the handover success ration, Deg_{Drop ratio} represents degradation related to the drop ratio, and th1, th2 , and th3 represent thresholds for the above degradation, respectively. With these example embodiments of the present disclosure, various KPIs may be monitored for determining whether the selected management profile applies a negative influence to the performance of the computing system.

In some example embodiments of the present disclosure, the management profiles may be sorted in an ascending order of energy saving ability. For example, in Table 1, the first profile may save less energy than the second profile. At this point, if the seventh profile leads to a serious degradation of KPI, the sixth profile may be selected to replace the seventh profile. If the sixth profile still results in an unacceptable negative influence, the fifth profile or a profile before the fifth profile may be selected. With these example embodiments, the degradation of the KPI may work as a feedback to adjust the selection of the current management profile. In other words, if the degradation is above the predefined threshold, it means that the current management profile is too aggressive in energy saving and thus a mild management profile may be selected.

The above paragraphs have provided descriptions for managing the power supply of the computing system, in other example embodiments of the present disclosure, other aspects of the computing system may be managed. For example, the data amount to be processed by the computing system may be managed according to the selected management profile. It is to be understood that if a great amount of data goes into the computing system, resources in the computing system may be exhausted and then a potential fault may occur. At this point, the data amount may be managed based on the management profile so as to balance the workload of the computing system.

Specifically, if the workload estimation is above the first threshold, the data amount that is to be processed by the computing system may be decreased. For example, the data that enters into the computing system may be directed to another computing system. Alternatively and/or in addition to, the data may be held in a buffer until the workload estimation drops. If the workload estimation is below the second threshold, the data amount that is to be processed by the computing system may be increased. If the workload estimation is between the first threshold and the second threshold, the data amount that is to be processed by the computing system may be maintained. With these example embodiments, the traffic and workload of the computing system may be maintained in a proper level so as to ensure that the computing system works in an effective manner.

In some example embodiments of the present disclosure, the computing system may comprise a unit in a large-scale system. For example, the computing system may comprise a smaller computing system related to a cell in a communication system. At this point, an individual management profile may be selected based on workload estimation for the cell, and thus the power supply of each cell may be controlled individually in an accurate and effective manner.

For example, if a position of a terminal device is covered by multiple cells and the terminal device is connected in one cell with a heavy workload. A management profile may be selected based on the workload estimation, and the terminal device may be handed over to another cell with a light workload if the workload estimation is above a first threshold of the management profile. With these example embodiments of the present disclosure, workloads of each cell in the communication system may be balanced and thus the performance of the whole communication system may be increased.

In some example embodiments of the present disclosure, the above method 400 may be implemented in a distributed processing system comprising multiple processing sites. The distributed processing system may provide various services. For example, an online shopping system may be implemented in the distributed processing system, and resources in servers of the online shopping system may be managed by the above method 400. In another example, a cloud service system may be implemented in the distributed processing system for providing virtual machines (VMs) to users. Here, virtual resources in VMs may provide the users with computing and storage abilities. With the method 400 of the present disclosure, the virtual resources may be managed according to workload estimations, so as to increase the performance of the VMs.

Specifically, a group of management profiles may be defined in the distributed processing system. Further, individual workload estimation may be determined for each processing site and an individual management profile may be selected for each processing site. With the management profile, multiple aspects of each processing site may be managed based on its own management profile. For example, the workload may be represented by a usage ratio of active processors in the processing site. If the usage ratio estimation is above a first threshold in the management profile, more processors may be switched on for providing more powerful processing ability. If the usage ratio estimation is below a second threshold in the management profile, some of the active processors may be switched off. Further, the management profile may be used for controlling traffic entering into each processing site. If the workload estimation is too high, a portion of the traffic may be forwarded to another site; and if the workload estimation is to low, traffic may be forwarded from another site. Accordingly, processing sites in the distributed processing system may be maintained in good states.

In some example embodiments of the present disclosure, the above method 400 may be implemented in a distributed storage system comprising multiple storage devices. The workload of each storage device may be presented by a usage ratio of the storage device. If the workload estimation is between a first threshold and a second threshold in a selected management profile, incoming storage requests may be directed into the storage device. If the workload estimation is too high and goes beyond a first threshold in the selected management profile, incoming storage requests may be forwarded to another storage device.

The above paragraphs have described details about the method 400 for managing the computing system. Alternatively and/or in addition to, the method 400 may be implemented by an apparatus. In some example embodiments of the present disclosure, an apparatus capable of performing any step of the method 400. Here, the apparatus may be implemented in any computing device inside the computing system or outside of the computing system. The apparatus may comprises: means for obtaining a plurality of previous workloads of a computing system for a previous time duration; means for determining workload estimation for a future time duration based on the plurality of previous workloads; means for selecting, based on the workload estimation, a management profile from a group of management profiles for managing the computing system for the future time duration.

In some example embodiments of the present disclosure, the management profile may comprise a first threshold and a second threshold, and the apparatus may further comprise means for managing applied resources in the computing system.

In some example embodiments of the present disclosure, the means for managing the applied resources in the computing system may comprise: means for increasing the applied resources in the computing system in response to the workload estimation being above the first threshold; means for decreasing the applied resources in the computing system in response to the workload estimation being below the second threshold; and means for maintaining the applied resources in the computing system in response to the workload estimation being between the first threshold and the second threshold.

In some example embodiments of the present disclosure, the means for selecting the management profile may comprise: means for determining a group of efficiencies for the computing system associated with the group of management profiles, respectively; and means for selecting the management profile based on the group of efficiencies for the computing system.

In some example embodiments of the present disclosure, the means for determining the group of efficiencies may comprise: means for determining, with regard to a given management profile in the group of management profiles, a given efficiency for the computing system associated with the given management profile based on an amount of energy that is to be saved in the computing system by a decrease of the power supply.

In some example embodiments of the present disclosure, the means for determining the given efficiency may comprise: means for specifying a target amount of applied resources that are to be saved in the computing system by the decrease of the applied resources; means for determining a false ratio for incorrectly managing the computing system based on the workload estimation and the management profile; and means for updating the given efficiency based on the target amount of applied resources and the false ratio.

In some example embodiments of the present disclosure, the means for determining the false ratio may comprise: means for determining the false ratio based on workloads of a previous time window within the previous time duration, the previous time window ending at a current time point.

In some example embodiments of the present disclosure, the false ratio may comprise any of: a false decreasing ratio associated with incorrectly decreasing the applied resources in the computing system; and a false maintaining ratio associated with failing to increase the applied resources in the computing system.

In some example embodiments of the present disclosure, the apparatus may further comprise: means for obtaining a performance indicator of the computing system; and means for selecting a further management profile from the group of management profiles in response to determining that degradation of the performance indicator being above a threshold degradation

In some example embodiments of the present disclosure, the further management profile may comprise any of: a first threshold that is below the first threshold of the management profile; and a second threshold that is below the second threshold of the management profile.

In some example embodiments of the present disclosure, the means for determining the workload estimation may comprise: means for determining, at a processor in the computing system, the workload estimation based on a machine learning model trained by historical workloads of the computing system.

In some example embodiments of the present disclosure, the management profile may comprise a first threshold and a second threshold, and the apparatus may further comprise means for managing the data amount that is to be processed by the computing system.

In some example embodiments of the present disclosure, the means for managing the data amount that is to be processed by the computing system may comprise: means for decreasing the data amount in response to the workload estimation being above the first threshold; means for increasing the data amount in response to the workload estimation being below the second threshold; and means for maintaining the data amount in response to the workload estimation being between the first threshold and the second threshold.

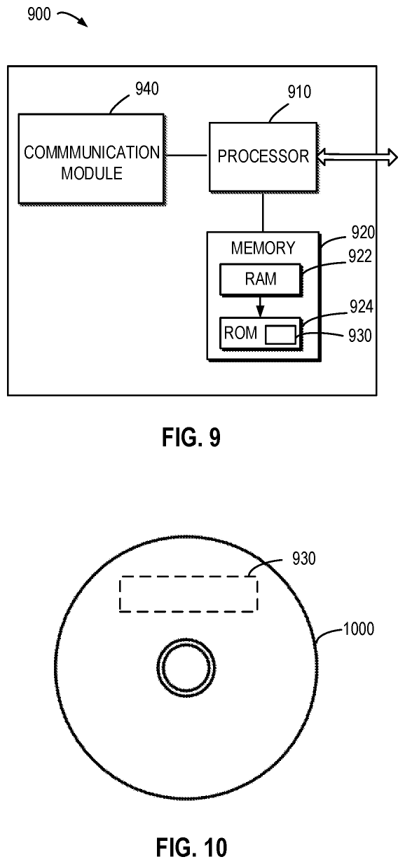

FIG. 9 is a simplified block diagram of a device 900 that is suitable for implementing embodiments of the present disclosure. The device 900 may be provided to implement the computing device. As shown, the device 900 includes one or more processors 910, one or more memories 920 coupled to the processor 910, and one or more communication modules 940 coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 920. The processor 910 may perform any suitable actions and processing by loading the program 930 into the RAM 920.

The embodiments of the present disclosure may be implemented by means of the program 930 so that the device 900 may perform any process of the disclosure as discussed with reference to FIGS. 3 to 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIGS. 3-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A device, comprising:
at least one processor; and
at least one memory including computer program codes;
the at least one memory and the computer program codes are configured to, with the at least one processor, cause the device to:
obtain a plurality of previous workloads of a computing system for a previous time duration;
determine workload estimation for a future time duration based on the plurality of previous workloads; and
select, based on the workload estimation, a management profile from a group of management profiles for managing the computing system for the future time duration.

2. The device of claim 1, wherein the management profile comprises a first threshold and a second threshold, and the device is further caused to manage applied resources in the computing system by any of:
increasing the applied resources in the computing system in response to the workload estimation being above the first threshold;
decreasing the applied resources in the computing system in response to the workload estimation being below the second threshold; and
maintaining the applied resources in the computing system in response to the workload estimation being between the first threshold and the second threshold.

3. The device of claim 2, wherein the device is further caused to select the management profile by:
determining a group of efficiencies for the computing system associated with the group of management profiles, respectively; and
selecting the management profile based on the group of efficiencies for the computing system.

4. The device of claim 2, wherein the device is further caused to determine the group of efficiencies by: with regard to a given management profile in the group of management profiles,
determining a given efficiency for the computing system associated with the given management profile based on an amount of applied resources that are to be saved in the computing system by a decrease of the applied resources, the determining the given efficiency comprising
specifying a target amount of applied resources that are to be saved in the computing system by the decrease of the applied resources;
determining a false ratio for incorrectly managing the computing system based on the workload estimation and the management profile; and
updating the given efficiency based on the target amount of applied resources and the false ratio.

5. (canceled)

6. The device of claim 4, wherein the device is further caused to determine the false ratio by:
determining the false ratio based on workloads of a previous time window within the previous time duration, the previous time window ending at a current time point.

7. The device of claim 4, wherein the false ratio comprises any of:
a false decreasing ratio associated with incorrectly decreasing the applied resources in the computing system; and
a false maintaining ratio associated with failing to increase the applied resources in the computing system.

8. The device of claim 2, wherein the device is further caused to:
obtain a performance indicator of the computing system; and
select a further management profile from the group of management profiles in response to determining that degradation of the performance indicator being above a threshold degradation, the further management profile comprising any of:
a first threshold that is below the first threshold of the management profile; and
a second threshold that is below the second threshold of the management profile.

9. The device of claim 1, wherein the device is further caused to determine the workload estimation by:
determining, at a processor in the computing system, the workload estimation based on a machine learning model trained by historical workloads of the computing system.

10. The device of claim 1, wherein the management profile comprises a first threshold and a second threshold, and the device is further caused to manage a data amount that is to be processed by of the computing system by any of:
decreasing the data amount in response to the workload estimation being above the first threshold;
increasing the data amount in response to the workload estimation being below the second threshold; and
maintaining the data amount in response to the workload estimation being between the first threshold and the second threshold.

11. A method for managing a computing system, comprising:
obtaining a plurality of previous workloads of the computing system for a previous time duration;
determining workload estimation for a future time duration based on the plurality of previous workloads; and
selecting, based on the workload estimation, a management profile from a group of management profiles for managing the computing system for the future time duration.

12. The method of claim 11, wherein the management profile comprises a first threshold and a second threshold, and the method further comprises managing applied resources in the computing system, comprising:
increasing the applied resources in the computing system in response to the workload estimation being above the first threshold;
decreasing the applied resources in the computing system in response to the workload estimation being below the second threshold; and
maintaining the applied resources in the computing system in response to the workload estimation being between the first threshold and the second threshold.

13. The method of claim 12, wherein selecting the management profile comprises:
determining a group of efficiencies for the computing system associated with the group of management profiles, respectively; and
selecting the management profile based on the group of efficiencies for the computing system.

14. The method of claim 13, wherein determining the group of efficiencies comprises: with regard to a given management profile in the group of management profiles,
determining a given efficiency for the computing system associated with the given management profile based on an amount of applied resources that are to be saved in the computing system by a decrease of applied resources, the determining the given efficiency comprising
specifying a target amount of applied resources that are to be saved in the computing system by the decrease of the applied resources;
determining a false ratio for incorrectly managing the computing system based on the workload estimation and the management profile; and
updating the given efficiency based on the target amount of applied resources and the false ratio.

15. (canceled)

16. The method of claim 4, wherein determining the false ratio comprises:
determining the false ratio based on workloads of a previous time window within the previous time duration, the previous time window ending at a current time point.

17. The method of claim 4, wherein the false ratio comprises any of:
a false decreasing ratio associated with incorrectly decreasing the applied resources in the computing system; and
a false maintaining ratio associated with failing to increase the applied resources in the computing system.

18. The method of claim 12, wherein the method further comprises:
obtaining a performance indicator of the computing system; and
selecting a further management profile from the group of management profiles in response to determining that degradation of the performance indicator being above a threshold degradation, the further management profile comprising any of:
a first threshold that is below the first threshold of the management profile; and
a second threshold that is below the second threshold of the management profile.

19. The method of claim 11, wherein determining the workload estimation comprising:
determining, at a processor in the computing system, the workload estimation based on a machine learning model trained by historical workloads of the computing system.

20. The method of claim 11, wherein the management profile comprises a first threshold and a second threshold, and the method further comprises managing a data amount that is to be processed by the computing system, comprising:
decreasing the data amount in response to the workload estimation being above the first threshold;
increasing the data amount in response to the workload estimation being below the second threshold; and
maintaining the data amount in response to the workload estimation being between the first threshold and the second threshold.

21. (canceled)

22. A non-transitory computer readable medium comprising program instructions for causing an apparatus to perform at least the method of claim 11.
